(19) United States
(12) Patent Application Publication
(10) Pub. No.: US 2024/0169329 A1
(43) Pub. Date: May 23, 2024

(54) SYSTEMS AND METHODS FOR MACHINE-LEARNING BASED ACTION GENERATION

(71) Applicant: Capital One Services, LLC, McLean, VA (US)

(72) Inventors: Jennifer KWOK, Brooklyn, NY (US); Tania Cruz MORALES, Washington, DC (US); Sara Rose BRODSKY, New York, NY (US); Abhay DONTHI, Washington, DC (US); Joshua EDWARDS, Carrollton, TX (US); Jason ZWIERZYNSKI, Chapel Hill, NC (US)

(73) Assignee: Capital One Services, LLC, McLean, VA (US)

(21) Appl. No.: 18/058,172

(22) Filed: Nov. 22, 2022

(51) Int. Cl. G06Q 20/10

(52) U.S. Cl. CPC G06Q 20/102

(57) ABSTRACT

A method for machine-learning based action generation, and more specifically, using machine-learning to dynamically adjust financial account payments and fees. The method may comprise: receiving user data; determining whether a trigger condition has been met; upon determining that a trigger condition has been met, generating, using a trained machine-learning model, one or more actions based on the user data associated with the user, wherein the trained machine-learning model has been trained based on (i) training user data and (ii) training action data, to learn relationships between the training user data and the training actions data, such that the trained machine-learning model is configured to use the learned relationships to generate one or more actions in response to input of the user data associated with the user; selecting a first action of the one or more actions; and automatically executing the first action.

### TECHNICAL FIELD

Various embodiments of this disclosure relate generally to machine-learning based action generation, and, more particularly, to systems and methods for dynamically adjusting credit card payments and fees.

### BACKGROUND

Even the best customers (e.g., customers of a financial institution or other entity) occasionally miss payments, for example, a minimum payment due on a credit card debt. Missed payments are usually a result of a genuine mistake or oversight, for example, a customer's failure to receive a notification of the payment due to a changed physical or electronic address of a customer, an accidental disabling of auto-pay by an inadvertent click or tap on a digital check box, or when a physical payment sent to the financial institution is inadvertently lost in the mail. When such payments are missed, a late fee is typically assessed, and the customer may contact the financial institution to request that the fee be waived. If upon review such a waiver is deemed appropriate, the financial institution may determine to waive the fee. Financial institutions may receive hundreds or even thousands of such calls or messages every day regarding late (or other types) of fee waivers, resulting in significant burdens on both human resources and on technical systems of the financial institution. Customers are inconvenienced by having to call and wait on hold with the institution to obtain a waiver of the fee or seek other means of restructuring a payment. Furthermore, if the customer service experience is unpleasant or not flexible enough to adapt to customers who may not be able to or may not desire to pay additional fees, there is a risk of the debt being “charged off” (e.g., when a bank or financial institution declares a debt such as credit card debt uncollectable after 180 days of missed minimum payments). Customer satisfaction is an important aspect in ensuring payments are received on debt. Prior solutions have attempted to apply rigid business logic to determine when to waive fees, for example, automatically waiving a first missed payment fee. But these types of approaches are not flexible, personalized, or responsive to an individual customer's situation or profile, nor do they result in an outcome that more likely results in the least amount of processing time on the part of a financial institution.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for machine-learning based action generation. In one aspect, an exemplary embodiment of a computer-implemented method for machine-learning based action generation may include: receiving user data associated with a user; determining whether a trigger condition has been met; upon determining that the trigger condition has been met, generating, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user; selecting first action of the one or more actions; and automatically executing the first action.

In one aspect, an exemplary embodiment of a computer-implemented method for machine-learning based action generation may include: receiving user data associated with a user; determining whether a trigger condition has been met, wherein the trigger condition is a missed payment by the user; upon determining that the trigger condition has been met, generating, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user; and causing to display, via a graphical user interface, graphical indications of the one or more actions.

In a further aspect, an exemplary embodiment of a system for action generation using machine-learning models may include: a memory storing instructions; and at least one processor operatively connected to the memory and configured to execute the instruction to perform operations. The operations may include: receiving, by one or more processors, user data associated with a user; determining, by the one or more processors, whether a trigger condition has been met, wherein the trigger condition is a missed payment by the user; upon determining that the trigger condition has been met, generating, by the one or more processors, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user; selecting, by the one or more processors, a first action of the one or more actions; automatically executing, by the one or more processors, the first action; and causing to display, by the one or more processors, via a graphical user interface, graphical indications of the one or more actions.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating one or more actions using a machine-learning model, according to one or more embodiments.

FIG. 2 depicts a flow diagram for generating one or more actions using a machine-learning model, according to one or more embodiments.

FIG. 3 depicts a flowchart of an exemplary computer-implemented method of generating one or more actions using a machine-learning, according to one or more embodiments.

FIG. 4 depicts an example of a computing device, according to one or more embodiments.

### DETAILED DESCRIPTION OF EMBODIMENTS

According to certain aspects of the disclosure, methods and systems are disclosed for machine-learning based action generation, e.g., using customer data and credit profile data and determining appropriate actions to take upon detecting a missed payment or another trigger condition. Customers who regularly make payments may occasionally miss payments, which may require interaction between the financial institution and the customer to resolve. A financial institution's human resources and technical systems as well as customers may be burdened during such interactions. Further, a non-flexible or unresponsive approach to some customers who miss payments may result in charge-off of debt, resulting in additional costs to the financial institution including both debt collection attempts as well as loss of payments on the charged-off debt. Conventional techniques, however may not be suitable. For example, conventional techniques may not dynamically adjust or automatically initiate optimal actions that are tailored to each specific customer. Accordingly, improvements in technology relating to machine-learning based action generation are needed.

As will be discussed in more detail below, in various embodiments, systems and methods are described for using machine-learning to generate one or more actions based on user data associated with a user. By training a machine-learning model, e.g., via supervised or semi-supervised learning, to learn associations between training user data that includes information regarding matters associated with one or more prior users and training action data that includes prior actions for the one or more prior users in response to trigger conditions, the trained machine-learning model may be usable to generate one or more actions based on user data associated with a user.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine-learning system may learn that a customer has missed a payment on a credit card balance. Upon receiving missed payment information, the machine-learning system may receive data from internal sources, including prior customer transaction data (e.g., recent purchases associated with credit card, merchant information, information regarding items purchased, other data associated with risk such as possibility of fraud or other criminal activity), payment settings data (e.g., enablement of auto pay, linked bank account, whether notifications are enabled or user unsubscribed from notifications, and so forth), repayment history data (e.g., number of on time payments made for the credit card account, amounts paid, whether a portion or the full balance paid, timeliness of payments), and other relevant customer data (e.g., customer income, demographic information, other financial accounts, data indicating that the customer is fiscally responsible). The machine-learning system may also receive data from an external data source, for example, a credit profile or credit score from a third party entity (e.g., Experian, TransUnion, Equifax, and so forth). Upon determining that the customer has missed the payment, the machine-learning system 135, via trained machine-learning model 150, may automatically generate a plurality of actions and/or select the most optimal action that would likely result in the least amount of processing time for the financial institution and/or would likely not result in “charge-off” of the debt. For example, the actions generated or selected by the machine-learning system may include waiving the late fee, reducing the late fee, extending the statement due date, and/or adjusting a minimum balance. The machine-learning system can automatically generate and/or execute the most optimal action based on each customer's unique circumstances, resulting in a more efficient and effective system. In this manner, both the customer service experience and the likelihood of the customer successfully making payments is improved, while the technical data workload and expenses for the financial institution are reduced.

While the example above involves missed credit card payments, it should be understood that techniques according to this disclosure may be adapted to any suitable type of trigger condition, for example, overdraft fees associated with an overdrawn bank account or missed payments associated with other types of loan instruments such as a mortgage or personal loan. It should also be understood that the example above is illustrative only. The techniques and technologies of this disclosure may be adapted to any suitable activity.

Presented below are various aspects of machine-learning techniques that may be adapted to generate one or more actions based on user data associated with a user. As will be discussed in more detail below, machine-learning techniques adapted to generate one or more actions based on user data associated with a user, may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

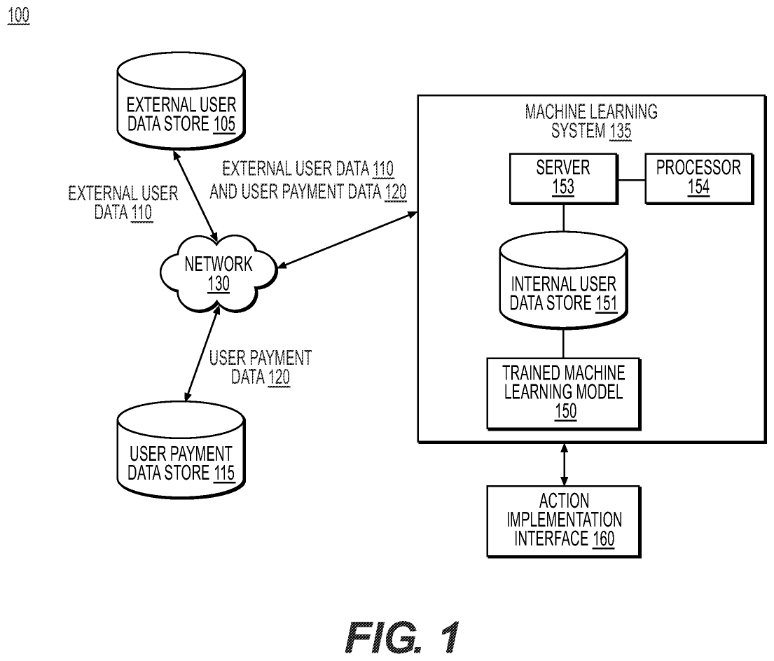

FIG. 1 depicts an exemplary environment 100 that may be utilized with techniques presented herein. The environment 100 as shown in FIG. 1 may include an external user data store 105, a user payment data store 115, a machine-learning system 135, and an action implementation interface 160, each of which may communicate across an electronic network 130. While a single (e.g., only one) external user data store 105 and a single (e.g., only one) user payment data store 115 are depicted in FIG. 1, it will be understood that the disclosure is not so limited. Rather, external user data store 105 may include a plurality of data stores, and user payment data store 115 may include a plurality of data stores. The external user data store 105 and the user payment data store 115 may be associated with a user (e.g., a customer of an entity associated with or having access to machine-learning system 135). The machine-learning system 135 may be associated with an entity, e.g., an entity associated with one or more of generating, training, or tuning a machine-learning model for one or more actions based on the user data associated with the user, generating, obtaining, or analyzing training user data that includes information regarding matters associated with one or more prior users and training action data that includes prior actions for the one or more prior users in response to trigger conditions, and/or automatically selecting an action based on the user data associated with the user.

In some embodiments, the components of the environment 100 are associated with a common entity, e.g., a financial institution, transaction processor, merchant, or the like. In some embodiments, one or more of the components of the environment 100 is associated with a different entity than another. The systems and devices of the environment 100 may communicate in any arrangement. As will be discussed herein, systems and/or devices of the environment 100 may communicate in order to one or more of generate, train, or use a machine-learning model to generate one or more actions based on the user data associated with the user, among other activities.

The action implementation interface 160 may be configured to enable a financial institution or other user to access and/or interact with other systems in the environment 100. For example, the action implementation interface 160 may be a computer system such as, for example, a desktop computer, a mobile device, a tablet, etc. In some embodiments, the action implementation interface 160 may include one or more electronic application(s), e.g., a program, plugin, browser extension, etc., installed on a memory of the action implementation interface 160. In some embodiments, the electronic application(s) may be associated with one or more of the other components in the environment 100. For example, the electronic application(s) of the action implementation interface 160 may include one or more of system control software, system monitoring software, software development tools, etc. for controlling, monitoring, and/or developing machine-learning system 135, trained machine-learning model 150, and/or components thereof.

The machine-learning system 135 may comprise a server 153, a processor 154, an internal user data store 151, and a trained machine-learning model 150. The server 153, according to some aspects of the disclosure, may include computer-readable memory such as a hard drive, flash drive, disk, etc. In some embodiments, the server 153 includes and/or interacts with an application programming interface for exchanging data to other systems, e.g., one or more of the other components of the environment 100. According to aspects of the disclosure, the internal user data store 151 may include and/or act as a repository or source for training user data and/or training action data as described further below.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the machine-learning system 135 may one or more of (i) generate, store, train, or use a trained machine-learning model 150 configured to generate and/or select one or more actions based on user data associated with the user, for example, external user data 110 and/or user payment data 120 as described further below. The machine-learning system 135 may include a machine-learning model and/or instructions associated with the machine-learning model, e.g., instructions for generating a machine-learning model, training the machine-learning model, using the machine-learning model etc. The machine-learning system 135 may include instructions for retrieving user data associated with a user, adjusting the user data associated with the user, e.g., based on the output of the machine-learning model, and/or operating action implementation interface 160 to output action decision data, e.g., as adjusted based on the machine-learning model. The machine-learning system 135 may include or be in communication with training data, e.g., training user data that includes information regarding matters associated with one or more prior users, and may include or be in communication with ground truth, e.g., training action data that includes prior actions for the one or more prior users in response to trigger conditions.

In some embodiments, a system or device other than the machine-learning system 135 is used to generate and/or train the machine-learning model. For example, such a system may include instructions for generating the machine-learning model, the training data and ground truth, and/or instructions for training the machine-learning model. As a result, trained machine-learning model 150 may then be provided to the machine-learning system 135.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between training user data that includes information regarding matters associated with one or more prior users and training action data that includes prior actions for the one or more prior users in response to trigger conditions, such that the trained machine-learning model is configured to determine an output one or more actions in response to the input user data associated with the user based on the learned associations.

Although depicted as separate components in FIG. 1, it should be understood that a component or portion of a component in the environment 100 may, in some embodiments, be integrated with or incorporated into one or more other components. For example, a portion of the action implementation interface 160 may be integrated into the machine-learning system 135 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to generate one or more actions based on the user data associated with the user are discussed in further detail in the methods below. In the following methods, various acts may be described as performed or executed by a component from FIG. 1, such as the machine-learning system 135, the trained machine-learning model 150, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

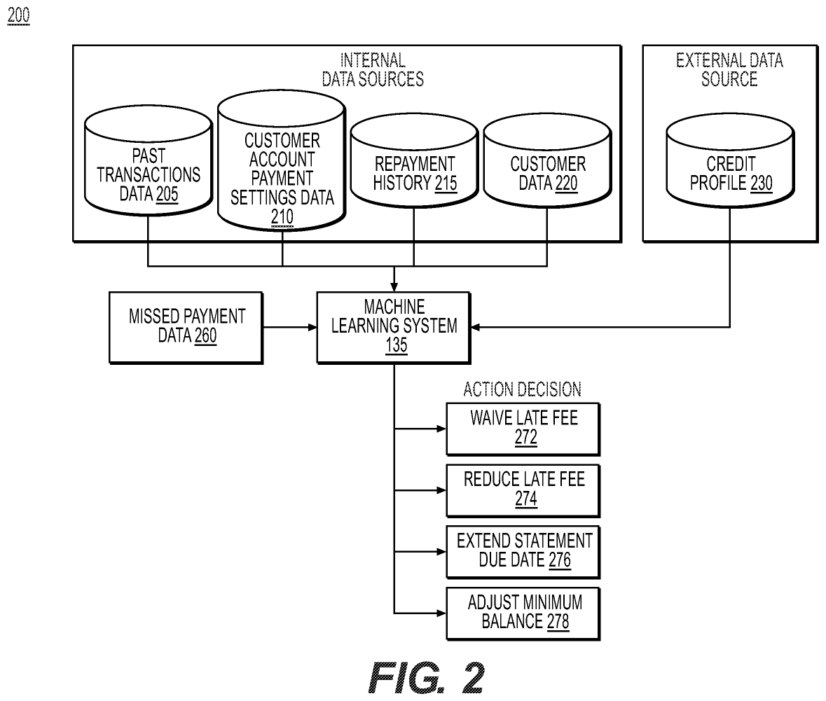

FIG. 2 depicts a flow diagram 200 for using generating one or more actions using a machine-learning model, according to one or more embodiments. As shown in FIG. 2, data from internal sources such as past transactions data 205, customer account payment settings data 210, repayment history data 215, and customer data 220 may be received by machine-learning system 135. According to some aspects of the disclosure, past transactions data 205 (e.g., prior customer transactions) may include, for example, recent purchases associated with a credit card, merchant information, information regarding items purchased, and other data associated with a potential risk associated with an account. For example, the regular purchase of high value luxury items, or regular purchases from overseas merchants, may be indicative of a customer with a higher payment risk profile, which may be relevant for determining an appropriate action. Customer account payment settings data 210 may include, for example, information indicating enablement of auto pay, a linked bank account for payments, whether notifications are enabled or if a user unsubscribed from notifications, and so forth. Customer account payment settings data 210 may be helpful to determine whether a customer intended to make payments but did not make a payment through some technical or physical error. For example, a customer may have mailed a physical check but the check was not received by the financial institution due to an error in filling out the address label. As another example, a user may have blocked or unsubscribed from notifications indicating a payment being due. As an additional example, a customer may have switched to a different bank account and closed the bank account associated with the auto-pay function, and failed to update the auto-pay. Repayment history data 215 may include data indicating the number of on-time payments made for the credit card account, the amounts paid, whether a portion or full balance paid, and the timeliness of payments. For example, a customer who has made hundreds of on-time payments, or often makes payments in full, is likely more financially responsible. Conversely, a customer who is regularly late making payments and only makes minimum balance payments may be considered a “charge-off” risk, where charging a fee might result in the customer being unable to pay the fee, further increasing the likelihood of a charge-off of the debt and ultimately a larger loss for the financial institution. Other customer data may also be relevant, for example, customer income, demographic information, the existence of other financial accounts with the financial institution, and other information that might be indicative of a customer's level of financial responsibility.

As shown in flow diagram 200, data from an external data source including customer credit profile 230 may be received at the machine-learning system 135. The customer credit profile 230 may include data such as a credit score obtained from a third party (e.g., Experian, TransUnion, Equifax, and so forth). In some examples, the credit score may be obtained based on customer consent authorizing the entity associated with the machine-learning system 135 to request and receive (e.g., access) the customer's credit score from the third party. In further examples, the customer consent may limit the ways in which the entity may use the credit score. For example, the credit score may only be used in one or more defined processes, such as analysis by the machine-learning system 135 to determine appropriate actions to take upon detecting a missed payment or another trigger condition. Credit score and other data obtained from external sources are indicative of financial responsibility and may further be helpful for the machine-learning system 135, via trained machine-learning model 150, to generate one or more actions. While a single (e.g., only one) external data source is depicted in FIG. 2, it is understood that data from a plurality of external data sources may be received by machine-learning system 135. For example, a first external user data source may be associated with a first credit score reporting agency, such as Experian, and a second external user data source may be associated with a second credit score reporting agency, such as TransUnion. The external user data 110 may thus comprise credit score information for a user received from both the Experian and the TransUnion data stores. According to some aspects, instead of receiving the information from a data store, the external user data 110 or user payment data 120 may be obtained from an access point, such as an application programming interface (API). As further shown in flow diagram 200, in addition to data from the internal data source(s) and the external data source(s), machine-learning system 135 may receive missed payment data 260. Missed payment data 260 may be, for example, data indicating that a payment on a credit card debt was not received by the financial institution by a determined deadline and may be received from internal user data store 151, which may include data kept or maintained by a financial institution or other entity operating or managing machine-learning system 135.

The machine-learning system 135, upon receiving the data described above, may generate or select one or more action decisions based on the data. In other words, based on the received inputs (e.g., missed payment data 260, data from internal data sources (such as past transactions data 205, customer account payment settings data 210, repayment history data 215, customer data 220) and external data sources (e.g., customer credit profile 230)), the machine-learning system 135 may, via trained machine-learning model 150, determine, and automatically execute and/or cause display of, via a graphical user interface, an action. Such an action may include, for example, one or more of a decision to waive late fee 272, reduce late fee 274, extend statement due date 276, or adjust minimum balance 278.

For example the machine-learning system 135, via trained machine-learning model 150, may determine that a customer with a high credit score and history of making timely payments potentially inadvertently missed a payment due to, for example, a bank account number that was recently changed. In this scenario, the machine-learning system 135, via trained machine-learning model 150, may determine that the waive late fee 272 decision is the optimal outcome here, to maintain customer loyalty and reduce burden on the financial institution systems. As another example, the machine-learning system 135, via trained machine-learning model 150, may determine that a customer has a moderate credit score and has repeatedly missed payments recently, but also has sufficiently high income and appears to (eventually) make their payments and pay off balances. In this situation, the machine-learning system 135, via trained machine-learning model 150, may generate or select the reduce late fee 274 action decision as the optimal action, to encourage better financial behavior from a customer who is otherwise able to make payments while still maintaining and/or encouraging customer loyalty.

As an additional example, machine-learning system 135, via trained machine-learning model 150, may determine that a customer with a moderate credit score and history of making timely payments has recently lost income and has begun missing payments, where the data indicates that the customer may have lost employment (due to, for example, lack of regular deposits in an associated bank account) or may have a temporary personal matter indicating a reduced ability to make payments. In this case, the machine-learning system 135, via trained machine-learning model 150, may generate or select the extend statement due date 276 action decision, such that the customer has an opportunity to return to making payments on time once certain employment or personal concerns are addressed. As a further example, the machine-learning system 135, via trained machine-learning model 150, may determine that a particular customer has a below-average credit score, regularly only makes minimum balance payments, and has a history of “charge-off” of debt, but is still currently making minimum-payments on some credit card accounts and debts including with the financial institution, but the customer has missed payments or has not paid debts on some other credit card accounts. In this scenario, the machine-learning system 135, via trained machine-learning model 150, may determine that the reduction in minimum balance 278 action decision (e.g., reducing a minimum amount due or reducing a total balance) may be the optimal action, which may avoid “charge-off” of the debt and increase customer loyalty while reducing burdens on the systems of the financial institution. According to some aspects of the disclosure, more than one action may be automatically implemented (e.g., for a particular customer, all three of the waive late fee 272 action decision, the extend statement due date 276 action decision, and adjust minimum balance 278 action decision may be chosen.) Other actions (e.g., action decisions) not described above may also be contemplated, for example, requesting additional information from the customer, altering the frequency of notifications, turning off paperless statements if emails appear to be missed or unread, providing targeted incentives for enrollment in automatic payments, increasing or adding an additional late fee or other fee, shortening the deadline for repayment, reporting the debt to a third party for debt collection, reporting the missed payment to a third party credit score institution, and so forth. Additionally, one or more of the actions (e.g., action decisions) may include contingent actions. For example, a late fee for a previously missed payment may be waived contingent on the customer making a subsequent payment on time.

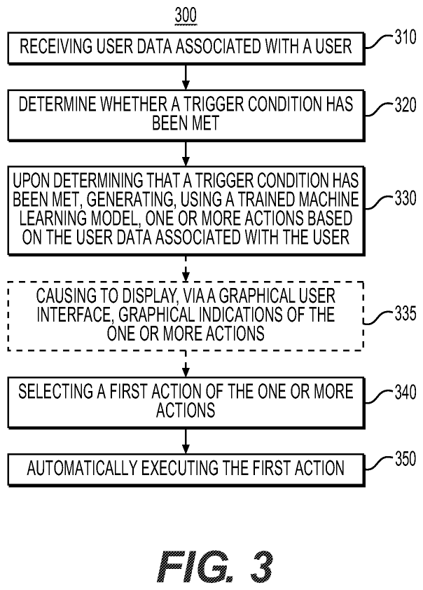

FIG. 3 illustrates an exemplary process 300 for generating one or more actions, e.g., by utilizing a trained machine-learning model such as a machine-learning model trained according to one or more embodiments discussed above. At step 310 of process 300, machine-learning system 135 may receive user data associated with a user, for example, external user data 110 and/or user payment data 120. External user data 110 may comprise data from an external data source, for example, customer credit profile or score information (e.g., customer credit profile 230) as described above with respect to FIG. 2. User payment data 120 may comprise data from internal data sources described above with respect to FIG. 2, for example, one or more of: location, timing, merchant identity, and/or purchase cost information (e.g., past transactions data 205); account payment alert settings information (e.g., customer account payment settings data 210); repayment history information (e.g., repayment history data 215); or customer-provided information (e.g., customer data 220). According to aspects of the disclosure, the user data associated with the user may be obtained from one or more internal databases associated with an entity (e.g., financial institution) and one or more external databases not associated with the entity (e.g., external database associated with a third party credit score company such as Experian, Transunion, Equifax, and the like). According to some aspects of the disclosure, the information described above may be received from a user or customer directly, for example, by input into a user interface associated with a user device of the user.

At step 320, the machine-learning system 135 may determine whether a trigger condition has been met. The trigger condition may be, for example, information or data indicating a missed payment by the user. For example, the user may be a customer of a financial institution with a credit card account including an outstanding balance. Based on the outstanding balance, there may be a due date with a minimum payment due for the user to transmit payment. When the machine-learning system does not receive at least the minimum payment by the due date, the machine-learning system 135 may determine that the trigger condition has been met. According to some aspects of the disclosure, another system or entity will determine that a payment is missed, and then a notification of the missed payment is sent to the machine-learning system 135. In some aspects, the trigger condition may be something other than a missed credit card account payment; for example, the trigger condition may instead be an overdrawn account notice, such as when money has been withdrawn from a bank account but it is later determined that there are insufficient funds in the account for the withdrawal. At step 320, when the machine-learning system determines a trigger condition as not been met, process 300 may return to step 310 to receive additional user data associated with the user. At step 330, upon determining that a trigger condition has been met, the machine-learning system 135 may generate, using a trained machine-learning model, such as trained machine-learning model 150, one or more actions based on the user data associated with the user. According to some aspects of the disclosure, the trained machine-learning model 150 may be trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model 150 is configured to use the learned relationships to generate from one or more actions in response to input of the user data associated with the user. In this manner, as described above with respect to FIG. 2, the machine-learning system 135 may use a trained machine-learning model, such as trained machine-learning model 150 described above at FIG. 1, to generate actions/action decisions based on the received customer data.

At step 340, the machine-learning system 135, via trained machine-learning model 150, may select a first action of the one or more actions. According to aspects of the disclosure, the first action may be one of the actions described above with respect to FIG. 2, for example: waiving a missed payment late fee (e.g., waive late fee 272); reducing the missed payment late fee amount (reduce late fee 274); extending a due date associated with the missed payment (extend statement due date 276); or adjusting a minimum balance due associated with the missed payment (adjust minimum balance 278). Other first actions are within the scope of the disclosure, for example, actions describe above with respect to FIG. 2. The machine-learning system 135 may select the first action of the one or more actions based on successful or failed outcomes of prior actions in response to similar situations. For example, the machine-learning system 135 would determine the action most likely to result in customer satisfaction, successful resolution of a debt, timeliness of repayment, minimization of interest and/or fees charged, or avoidance of a debt being charged off. According to aspects of the disclosure, the machine-learning system 135 may further select the first action of the one or more actions based on a user input received via a graphical user interface associated with a user. For example, the plurality of actions generated at step 330 by the machine-learning system 135 optionally may be transmitted for display on a graphical user interface associated with a user, or otherwise transmitted to a user at step 335. The user may then indicate which option they would prefer. For example, a user given the option of “waive late fee” and “extend statement due date” may choose to elect both options, or may instead choose to waive the late fee without choosing to extend the statement due date. The machine-learning system 135 may then automatically execute the first action selected by the user input as described below at step 350, without the need to require additional information or for the user to call or contact the financial institution.

At step 350, the machine-learning system 135 may automatically execute the first action. According to some aspects, the first action may be automatically implemented by the machine-learning system 135 via the action implementation interface 160, for example, a late fee may be automatically waived without requesting any input from the user or from the financial institution. As explained above, the action optionally may be executed after receiving a user input.

According to some aspects of the disclosure, at optional step 335, the machine-learning system 135 may further cause display, via a graphical user interface, of graphical indications of the one or more actions generated by the machine-learning system 135 at step 330. According to some aspects, the graphical indications of the one or more actions may further comprise graphical indications corresponding to one or more of: waiving a missed payment late fee (e.g., waive late fee 272); reducing the missed payment late fee amount (reduce late fee 274); extending a due date associated with the missed payment (extend statement due date 276); or adjusting a minimum balance due associated with the missed payment (adjust minimum balance 278) as described above with respect to FIG. 2. The graphical user interface may be a web-based or a mobile version of a user interface of an application (e.g., the application of the action implementation interface 160 described with reference to FIG. 1). In some examples, once the first action is selected and automatically executed (e.g., at respective steps 340 and 350), the graphical user interface may be updated to indicate the completion of the first action. In further examples, the graphical user interface may also display a history of actions taken by the machine-learning system 135 (e.g., based on past user data and one or more past triggers conditions having been met). To provide an illustrative example, through the graphical user interface, a customer may view if and when their credit card payment due date had previously been extended, or if a late fee was previously waived or reduced. The actions and action history may also be displayed to a call center agent when a customer calls for support. In some examples, the actions and action history for the customer may be retrieved and shared to the call center agent by an interactive voice response (IVR) system that initially interacts with the customer when the customer calls to, e.g., obtain a customer name, account details, etc. The action history may also be available to the customer or a call center agent via text message or online chat. The customer may further request an email or push notification within the application (e.g., of the action implementation interface 160).

According to additional aspects of the disclosure, the trained machine-learning model 150 may further generate a decision for a second or follow-up action after the first action is executed. According to some aspects, the trained machine-learning model 150 may be tuned based on a result or outcome of the first action. For example, the trained machine-learning model may be generate a decision for a second action based on a result of the first decision. In one example, the machine-learning system 135 may execute a first action of waiving a missed payment late fee. The machine-learning system 135 may then receive information that the debt was subsequently paid off successfully. In this use case, the trained machine-learning model 150 may then take this into account when deciding on a second action in response to a future missed payment for the user. In this manner, the trained machine-learning model 150 can more accurately generate successful outcomes based on prior decisions. Similarly, in a case where waiving the missed payment late fee did not result in a successful outcome, the trained machine-learning model 150 may be trained based on the outcome to potentially suggest a different second action based on the result.

It should be understood that embodiments in this disclosure are exemplary only, and that other embodiments may include various combinations of features from other embodiments, as well as additional or fewer features. For example, while some of the embodiments above pertain to missed payment data, any suitable activity may be used. In an exemplary embodiment, instead of or in addition to missed credit card payment data, the trigger condition may instead include an overdraft or similar fee associated with an overdrawn bank account, an insufficient payment (e.g., where at least a minimum balance was not paid), a declined payment, or an exceeded credit limit; in these cases, data retaining to recurring deposits of paycheck and other relevant information may be used to train the machine-learning model to generate or select appropriate actions.

In general, any process or operation discussed in this disclosure that is understood to be computer-implementable, such as the process illustrated in FIG. 3 may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

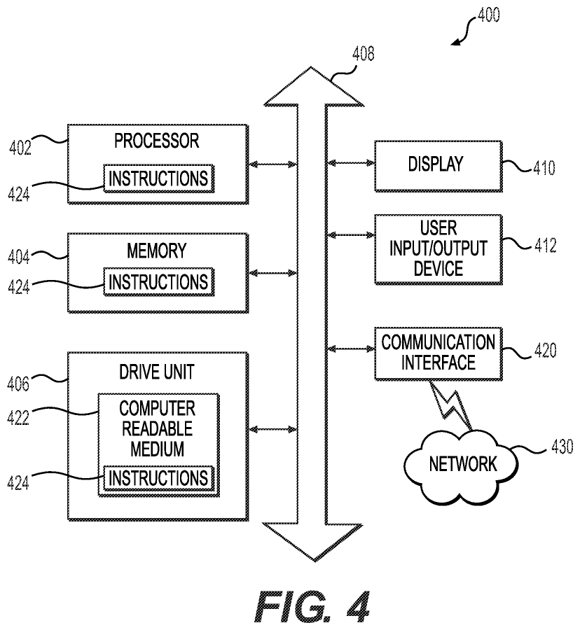

FIG. 4 is a simplified functional block diagram of a computer 400 that may be configured as a device for executing the computer-implemented methods of FIG. 3, according to exemplary embodiments of the present disclosure. For example, the computer 400 may be configured as the machine-learning system 135 and/or another system according to exemplary embodiments of this disclosure. In various embodiments, any of the systems herein may be a computer 400 including, for example, a data communication interface 420 for packet data communication. The computer 400 also may include a central processing unit (“CPU”), such as processor 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications over network 430 (e.g., similar to network 130). The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for machine-learning based action generation, the method comprising:
receiving, by one or more processors, user data associated with a user;
determining, by the one or more processors, whether a trigger condition has been met;
upon determining that the trigger condition has been met, generating, by the one or more processors, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user;
selecting, by the one or more processors, a first action of the one or more actions; and
automatically executing, by the one or more processors, the first action.

2. The computer-implemented method of claim 1, further comprising:
causing to display, by the one or more processors, via a graphical user interface, graphical indications of the one or more actions.

3. The computer-implemented method of claim 1, wherein the user data associated with the user comprises one or more of:
matter information comprising one or more of: location, timing, merchant identity, and/or purchase cost information;
account payment alert settings information;
repayment history information;
customer-provided information; or
customer credit profile or score information.

4. The computer-implemented method of claim 3, wherein the user data associated with a user is obtained from one or more internal databases associated with an entity and one or more external databases not associated with the entity.

5. The computer-implemented method of claim 1, wherein the trigger condition is a missed payment by the user.

6. The computer-implemented method of claim 1, wherein the first action is one of:
waiving a missed payment late fee;
reducing a missed payment late fee amount;
extending a missed payment due date; or
adjusting a minimum balance due associated with a missed payment.

7. The computer-implemented method of claim 2, wherein the first action of the one or more actions is selected based on a user input received via the graphical user interface.

8. The computer-implemented method of claim 2, wherein the graphical indications of the one or more actions further comprise graphical indications corresponding to one or more of:
waiving a missed payment late fee;
reducing a missed payment late fee amount;
extending a missed payment due date; or
adjusting a minimum balance due associated with a missed payment.

9. The computer-implemented method of claim 4, wherein the customer credit profile or score information is obtained from the one or more external databases.

10. The computer-implemented method of claim 9, wherein the matter information, account payment alert settings information, repayment history information, and customer-provided information are obtained from the one or more internal databases.

11. A computer-implemented method for action generation using a machine-learning model, the method comprising:
receiving, by one or more processors, user data associated with a user;
determining, by the one or more processors, whether a trigger condition has been met, wherein the trigger condition is a missed payment by the user;
upon determining that the trigger condition has been met, generating, by the one or more processors, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user; and
causing to display, by the one or more processors, via a graphical user interface, graphical indications of the one or more actions.

12. The computer-implemented method of claim 11, further comprising:
selecting, by the one or more processors, a first action of the one or more actions; and
automatically executing, by the one or more processors, the first action.

13. The computer-implemented method of claim 11, wherein the user data associated with the user comprises one or more of:
matter information comprising one or more of: location, timing, merchant identity, and/or purchase cost information;
account payment alert settings information;
repayment history information;
customer-provided information; or
customer credit profile or score information.

14. The computer-implemented method of claim 13, wherein the user data associated with a user is obtained from one or more internal databases associated with an entity and one or more external databases not associated with the entity.

15. The computer-implemented method of claim 12, wherein the action corresponding to the first action is one of:
waiving a missed payment late fee;
reducing a missed payment late fee amount;
extending a missed payment due date; or
adjusting a minimum balance due associated with a missed payment.

16. The computer-implemented method of claim 12, wherein the first action of the one or more actions is selected based on a user input received via the graphical user interface.

17. The computer-implemented method of claim 11, wherein the graphical indications of the one or more actions further comprise graphical indications corresponding to one or more of:
waiving a missed payment late fee;
reducing a missed payment late fee amount;
extending a missed payment due date; or
adjusting a minimum balance due associated with a missed payment.

18. The computer-implemented method of claim 14, wherein the customer credit profile or score information is obtained from the one or more external databases.

19. The computer-implemented method of claim 18, wherein the matter information, account payment alert settings information, repayment history information, and customer-provided information are obtained from the one or more internal databases.

20. A system for action generation using a machine-learning model, the system comprising:
at least one memory storing instructions; and
at least one processor executing the instructions to perform a process including:
receiving, by one or more processors, user data associated with a user;
determining, by the one or more processors, whether a trigger condition has been met, wherein the trigger condition is a missed payment by the user;
upon determining that a trigger condition has been met, generating, by the one or more processors, using a trained machine-learning model, one or more actions based on the user data associated with the user, wherein the trained machine-learning model has been trained based on (i) training user data that includes information regarding matters associated with one or more prior users and (ii) training action data that includes prior actions for the one or more prior users in response to trigger conditions, to learn relationships between the training user data and the training actions data, such that the trained machine-learning model is configured to use the learned relationships to generate one or more actions in response to input of the user data associated with the user;
selecting, by the one or more processors, a first action of the one or more actions;
automatically executing, by the one or more processors, the first action; and
causing to display, by the one or more processors, via a graphical user interface, graphical indications of each of the one or more actions.
